(19) United States
(12) Patent Application Publication
(10) Pub. No.: US 2016/0144986 A1
(43) Pub. Date: May 26, 2016

(54) DEVICE FOR STRAPPING PRODUCT STACKS

(71) Applicant: Ferag AG, Hinwil (CH)

(72) Inventor: Fabian Jauch, Elgg (CH)

(21) Appl. No.: 14/949,996

(22) Filed: Nov. 24, 2015

(30) Foreign Application Priority Data
Nov. 25, 2014 (CH) 01813/14

(51) Int. Cl. B65B 13/18; B65B 35/24; B65G 15/12; B65B 13/02

(52) U.S. Cl. CPC B65B 13/183; B65B 13/02; B65B 35/243; B65G 15/12

(57) ABSTRACT

A device for strapping product stacks, include a first conveying rest and a second conveying rest, which, in the conveying direction is arranged subsequently to and spaced from the first conveying rest. A strapping gap for strapping the product stack with a strapping tape is formed between the first and second conveying rest and transverse to the conveying direction. A side guidance device is arranged at both sides of the second conveying rest, and these side guidance devices laterally guide the product stacks, and with the second conveying rest enclose a conveying space. The side guidance devices each include at least one advance limitation element that can be driven in a circulatory manner, projects laterally into the conveying space and is designed to assume a contact fit with the product stack to prevent products or product units of the product stack from slipping apart in the conveying direction.

### BACKGROUND OF THE INVENTION

1. Field of the Invention

The invention lies in the field of conveying technology and relates to a device and to a method for strapping products stacks, wherein the device includes a first conveying rest and a second conveying rest, which is subsequent to the first conveying rest in the conveying direction and is arranged distanced to this, wherein a strapping gap for strapping the product stack with a strapping tape is formed between the first and second conveying rest and essentially transversely to the conveying direction.

2. Description of Related Art

Extensive or flat products, such as printed products, after their manufacture, are often grouped together into product stacks and strapped once or several times by way of a strapping device, for the subsequent transport. The strapping ensures that the product stack is held together.

The product stacks created, e.g. at a stacking device, must be fed to a strapping device for creating the strapping. For this, the product stacks, for example on a conveying belt, are conveyed into a strapping position in the strapping device. With this procedure, one should take care that the products that form the product stack do not mutually slip and that the product stack does not fall apart.

It is thus known to provide side guidance devices that laterally guide the product stacks conveyed on the conveying belt.

The published documents DE 102 03 903 A1 and DE 199 20 531 A1 in each case describe a device with a cross stacker and with a strapping device that connects to the cross stacker and is for strapping the product stack. The product stack is created by way of the cross stacker (stack turner) and is conveyed into a strapping position via a conveying rest. The product stack is hereby laterally guided by way of lateral guide and transport walls, which are designed in the manner of an endless conveying belt, and are provided with advance lugs. The advance lugs run behind the product stack in the conveying direction and push the product stack against a package abutment, which can be moved into the conveying space. The package abutment is formed by abutment rods, which are stationary on operation. The product stack, which is not yet strapped, is guided and supported to the side by the lateral guide walls and to the rear by advance lugs, during the advance movement. Only in the strapping position is the product stack supported to the front in the conveying direction by way of the stationary package abutment.

The described devices thus have the disadvantage that the package abutments are stationary on operation. Not until reaching the strapping position, do the product stacks come to abut on the package abutment with their leading stack side. The stacks, however, during their conveying into the strapping position remain unguided to the front in the conveying direction.

More and more complex product units are created in the field of processing printed products, and these product units apart from printed products such as magazines, newspapers leaflets or brochures, yet comprise supplements such as goods samples, data carriers or advertising material. This leads to the individual product units as well as the product stacks formed from such product units becoming unshaped. The shapelessness in particular is characterised in that the individual products or products units do not have a constant thickness. Accordingly, the product units grouped together into a product stack no longer lie on one another in a flat or extensive manner, by which means the products stack is compromised in its stability.

The conveying of such product stacks out of the stacking device up to the assumption of the strapping position and the implementation of a first strapping becomes increasingly more demanding due to this. It is particularly when accelerating and braking the product stack that there exists the danger of products such as supplements or goods samples, which is to say product units, slipping out of the product stack due to the occurring inertia forces, and of the product stack falling apart.

### SUMMARY OF THE INVENTION

It is therefore the object of the invention, to suggest a device for strapping product stacks, which permits an optimal guiding of the product stacks that are conveyed into the strapping position, where this guiding is effected to each side.

The products stack in particular should be securely guided at every point in time of the conveying. Moreover, it should be ensured that the stability of the product stack is ensured at all times when accelerating and braking the unbound products stack.

In accordance with the present invention, a side guidance device is arranged in each case at both sides of the second conveying rest, considered in the conveying direction, and these side guidance devices laterally guide the product stacks and with the second conveying rest enclose a conveying space. The side guidance devices with the second conveying rest in particular form a conveying channel.

The side guidance devices moreover each include at least one advance limitation element, which can be driven in a circulatory manner, projects laterally into the conveying space or conveying channel and is designed to assume a contact fit with the product stack for the purpose of preventing products or product units from slipping away or slipping apart, out of the product stack in the conveying direction.

A “contact fit” is to be understood very generally as a physical contact such as friction contact or abutment.

The two side guidance devices associated with the second conveying rest can be driven via a common drive or via separate drives.

The advance limitation element in particular is designed to act upon the lateral and/or front stack side, in a front section of the product stack.

According to a further development of the invention, the advance limitation element is an advance limitation abutment, which considered in the conveying direction, can be moved relative to the product stack in a leading manner, in the conveying space.

According to another further development of the invention, the advance limitation element is a friction element, which is designed to create a friction contact with the stack side, which is lateral in the conveying direction. The lateral stack side is the stack side facing this side guidance device.

The two side guidance devices as a result lie opposite one another, wherein the second conveying rest is arranged therebetween.

The advance limitation elements of the two side guidance devices are moved through the conveying space or conveying channel in a manner in which they are aligned to one another. The two side guidance devices are driven synchronously to one another.

The advance limitation element serves for guiding the product stack to the front in the conveying direction, when this product stack is stopped on reaching the strapping position.

The product stack in particular is formed by at least two product units that are placed on one another. The product units include at least one printed product, such as newspaper, magazine, brochure or leaflet. The product units can also include a plurality of products that are inserted into one another. Moreover, the product units can also include supplements such as products samples, data carriers or advertising supplements. The products units in particular can also be envelopes with inserted advertising supplements.

The first and the second conveying rest are arranged serially, i.e. successively, along the conveying direction.

The strapping gap formed between the first and the second conveying rest in particular is part of a strapping space, within which the strapping of the product stack takes place. The strapping space lies in a plane that is aligned vertically and transversely to the conveying direction of the product stack. The strapping space can be delimited by a belt guidance channel.

The strapping of the product stack in particular is effected transversely to the conveying direction of the products stack. The strapping tape, with which the product stack is strapped, can be of plastic or metal. The strapping tape can also be a textile formation such as woven fabric or cord of plastic fibres or natural fibres.

According to a further development of the side guidance devices, these in each case comprise at least one guiding body, which is driven in a circulatory manner about at least two deflection elements, which are spaced from one another. The guiding body in particular is flexible. The deflection elements are arranged perpendicularly to the conveying rest.

The at least one advance limitation element is hereby particularly arranged on the guiding body and is moveable with guiding body in a circulatory manner.

The second conveying rest is driven via a drive.

According to a further development of the device, the second conveying rest is formed by a circulatorily driven conveying belt, in particular of a belt conveyor.

The second conveying rest in particular is aligned horizontally. The conveying rest or the conveying belt can be integrated into a working table of the device.

The advance limitation element serves for the guiding and support of the stack region, which is at the front in the conveying direction, which is to say the front stack side, on braking the product stack when reaching the strapping position.

According to a further development of the device, a side guidance device is likewise arranged in each case on both sides of the first conveying rest, considered in the conveying direction. The two side guidance devices laterally guide the product stack. Together with the conveying rest they form a conveying space. The conveying space is a conveying channel.

According to a further development of the side guidance devices associated with the first conveying rest, these include at least one advance limitation element, which can be driven in a circulatory manner, projects laterally into the conveying space or conveying channel and is designed to assume a contact fit with the product stack, for the purpose of preventing individual products or product units from slipping away from the product stack in the conveying direction.

According to a further development of the invention, the advance limitation element is an advance limitation abutment which, in the conveying space, can be moved in the conveying direction in a leading manner relative to the product stack.

According to another further development of the invention, the advance limitation element is a friction element, which is designed to create a friction contact with the stack side that is lateral in the conveying direction, i.e. with the stack side facing this side guidance device.

The two side guidance devices as a result lie opposite one another, wherein the first conveying rest is arranged therebetween.

The two side guidance devices associated with the first conveying rest can be driven via a common drive or via separate drives.

The advance limitation elements of the two side guidance devices are moved through the conveying space or the conveying channel, in a manner in which they are aligned to one another. The two side guidance devices are driven synchronously with one another.

The two pairings of side guidance devices for the first and the second conveying rest are driven synchronously to one another.

The advance limitation element likewise serves for guiding and supporting the stack region that is at the front in the conveying direction, which is to say the front stack side, before the product stack with its front stack side is conveyed over the strapping gap and gets into the region of influence of the second conveying rest.

If, for example, the conveyed product stack has to be braked before having reached its strapping position, then the advance limitation element ensures that products or product units of the stack cannot slip to the front.

According to a further development of the side guidance device for the first conveying rest, this includes at least one advance abutment that can be driven in a circulatory manner and that can be moved in the conveying space or conveying channel in the conveying direction in a trailing manner relative to the product stack.

The products stack considered in the conveying direction is supported to the rear via the advance abutment on accelerating the product stack.

The product stack can moreover be pushed in the conveying direction, into the strapping position, by way of the advance abutment.

The advance abutments of the two side guidance devices are moved through the conveying space or the conveying channel, in a manner aligned to one another. The two side guidance devices with the advance abutments are driven synchronously to one another.

It is possible for the side guidance devices associated with the first conveying rest in each case to comprise at least one leading advance limitation element as well as at least one trailing advance abutment. The product stack, considered in the conveying direction, is guided to both sides as well as to the front and to the rear by way of this, and supported against slippage.

According to a further development of the invention, the side guidance devices for the first conveying rest in each case include at least one guiding body driven in a circulatory manner about at least two deflection elements that are spaced from one another. The guiding body in particular is flexible. The deflection elements are arranged perpendicularly to the conveying rest.

If at least one advance limitation element is provided, then the advance limitation element is arranged on the guiding body and is movable with the guiding body in a circulatory manner.

If the least one advance abutment is provided, then this is arranged on the guiding body and is movable with the guiding body in a circulatory manner.

If at least one advance limitation element as well as at least one advance abutment is provided, then these are arranged on a common or on different guiding bodies and are movable with the common or different guiding bodies in a circulatory manner.

The second conveying rest is driven via a drive. The first and second conveying rest can be driven via separate drives or via a common drive. The two conveying rests are driven in a synchronous manner.

According to a further development of the device, the first conveying rest is formed by a circulatorily driven conveying belt, in particular of a belt conveyor.

The first conveying rest is aligned horizontally. The first conveying rest or the conveying belt can be integrated into a working table of the device.

According to a further development of the invention, the device includes a displacement device, by way of which at least one, in particular two side guidance devices of a pairing of side guidance devices can be displaced out of their operational position into a passive position.

The displacement device can be designed to move at least one, in particular both side guidance devices of a pairing of side guidance devices between the operational position and the passive position via a translatory movement or a pivot movement or a combination of translatory movement and pivot movement.

According to a further development of the invention, the device includes a displacement device, by way of which at least one, in particular both side guidance devices of a pairing of side guidance devices are translatorily displaceable, and thus the distance between the two side guidance devices can be set. The displacement device can correspond to the displacement device described further above.

The guiding body of a side guidance device can be a strap (belt), a cable, a chain or a tape. The guiding body is a belt (tape) that forms a lateral guiding wall. The guiding wall is arranged perpendicularly to the conveying rest.

The belt can be designed in the manner of a continuous conveying belt. The belt can be a module belt chain with a plurality of module belt links that are connected to one another.

The deflection element can be a deflection roller. One or both of the at least two deflection rollers can be driven. The rotation axis of the deflection elements is arranged in each case perpendicularly to the conveying rest

The advance limitation element can have elastic characteristics. The advance limitation element can be designed from an elastic material, such as an elastomer, or comprise this.

The advance limitation element can be designed in a strip-like manner. The advance limitation element can extend vertically to the conveying rest.

The advance limitation element designed as a friction element can be designed as a brush or lamellae projecting into the conveying space.

The advance abutment can likewise be designed in a strip-like manner. The advance abutment can extend vertically to the conveying rest.

The side guidance devices, for example, can be fastened or hung on a holder arranged above the side guidance devices. The holder can, for example, be a traverse in the form of a transverse beam, which is arranged transversely to the conveying direction over the conveying rest.

The invention also relates to a method for strapping product stacks with a device according to the above description. The method includes the following steps:

conveying a product stack lying on the first conveying rest, in the conveying direction,

receiving the products stack which is conveyed by the first conveying rest, in particular beyond the strapping gap, by the second conveying rest,

conveying the product stack further into a strapping position, in which the product stack is arranged transversely over the strapping gap,

strapping the products stack with a strapping tape,

conveying the strapped product stack further,

wherein the advance limitation element of the at least one side guidance device of the second conveying rest is co-moved in the conveying direction, laterally of or leading the product stack, and at least on braking the product stack assumes a contact fit with this, so that products or product units of the product stack cannot slip away in the conveying direction.

In the strapping position, the product stack with a rear stack section, considered in the conveying direction, lies on the first conveying rest and with a front stack section on the second conveying rest.

The strapping of the product stack with a strapping tape is also called binding. The products or product units of the product stack are held together by way of the strapping and are secured against mutual slippage.

The binding can be a transverse or longitudinal binding. Several bindings can be carried out. A combined transverse and longitudinal binding has the advantage that this provides the product stack with an improved cohesion to all sides.

According to a further development of the invention, the advance limitation element is an advance limitation abutment that is co-moved in the conveying direction in a manner leading the product stack and such that products or product units of the product stack come to abut on the advance limitation abutment on braking the product stack.

According to a further development of the method, the advance limitation element is a friction element that is co-moved in the conveying direction, laterally to or leading the product stack, such that considered in the conveying direction, the lateral stack side of the product stack assumes a lateral friction contact with the advance limitation element on braking the product stack, so that products or product units of the products stack cannot slip away to the front in the conveying direction.

The advance limitation element can be moved at a lower speed than the associated second conveying rest. The advance limitation element can also be moved at the same speed as the second conveying rest. The speeds of the conveying rest and of the advance limitation element can be synchronous.

The circulatorily moved advance limitation element, in particular if is the case of an advance limitation abutment, in particular before the moving of the front stack side into between the side guidance devices, can be pivoted about the deflection elements out of a return section into the conveying space or conveying channel and be moved through the conveying space in a manner leading the product stack.

With this procedure, the product stack with the front stack side comes to abut with advance limitation abutment.

The circulatorily moved advance limitation element can also be pivoted about the deflection elements from a return section into the conveying space or conveying channel and be moved laterally of the product stack in a co-running manner through the conveying space, simultaneously with the moving of the product stack into between the side guidance devices.

The product stack is moved together with the advance limitation element into the strapping position.

With a further conveying of the strapped product stack, the advance limitation element at the end of the conveying space or conveying channel is moved about the deflection element back into the return section and moved back counter to the conveying direction.

The invention has the advantage that on braking the product stack, the products or product units can no longer slip away to the front due to the inertia force, by which means the product stack would fall apart.

Product stacks with shapeless products or product units which, e.g., do not lie on one another in a flat or extensive manner can be also be processed without any problem by way of this.

The quality of the bound product stack is also very high, since the product units of the product stack are not only aligned to the side but also to the front, on strapping.

The invention moreover permits the strapping of the product stacks in more rapid cycles, which inevitably entail greater accelerations. Thus, cycle times of below 2 seconds, for example, are possible thanks to the present invention. The product stacks are thereby moved at speeds of 0.5 to 1 m/s. The braking and acceleration ramps before or after the strapping of the product stack at standstill are accordingly steeper and the inertia forces resulting therefrom are accordingly large.

The products stacks, which are moved in the conveying direction into the strapping position, cannot impact the advance limitation elements, since the advance limitation elements on operation are not designed as stationary abutment elements but, in contrast, are co-moved in the conveying direction. Damage to the product stack or a rebounding of the product stack from the advance limitation elements is prevented by way of this.

A further advantage of the present invention also lies in existing strapping devices being able to be retrofitted with the technical features according to the invention, in a simple and inexpensive manner.

### BRIEF DESCRIPTION OF THE DRAWINGS

Examples of the invention are represented in the drawings and described hereinafter. Schematically there are shown in:

FIG. 1a-1e a perspective view of a device according to the invention, according to a first embodiment, in different operational positions;

FIG. 2 a perspective view of an a device according to the invention, according to a second embodiment;

FIG. 3 a perspective view of the fastening of the side guidance devices.

### DETAILED DESCRIPTION OF THE INVENTION

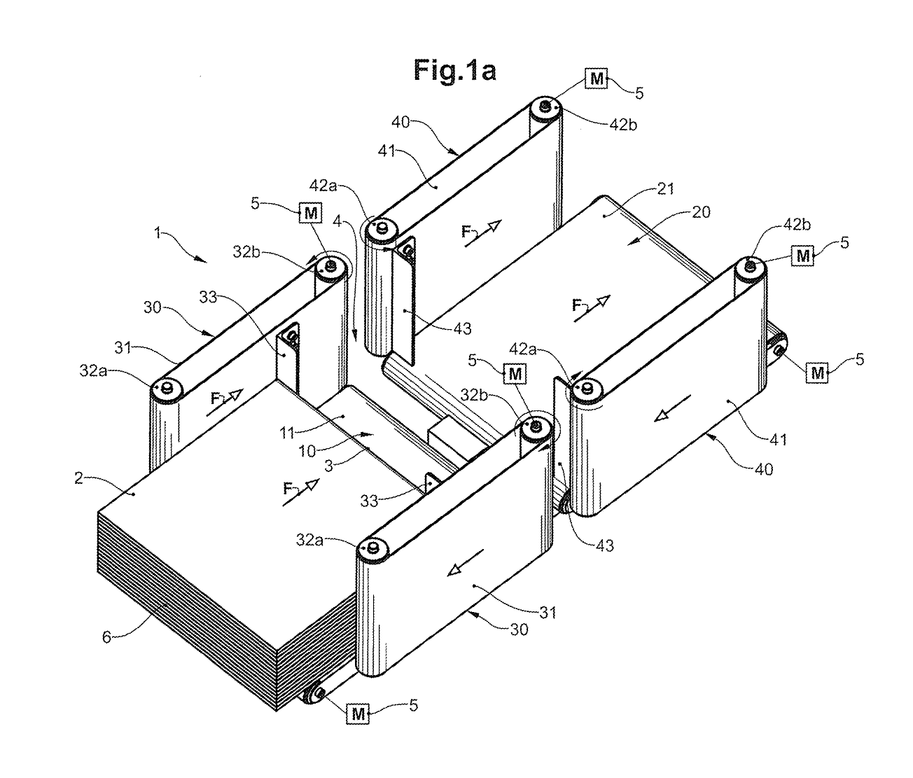

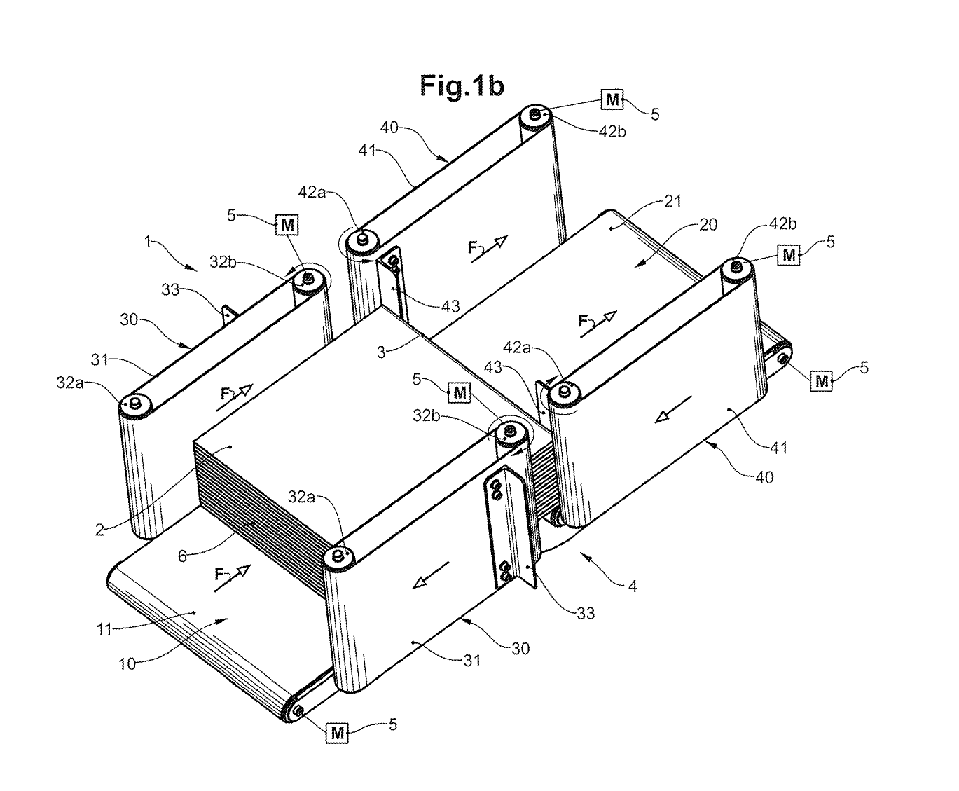

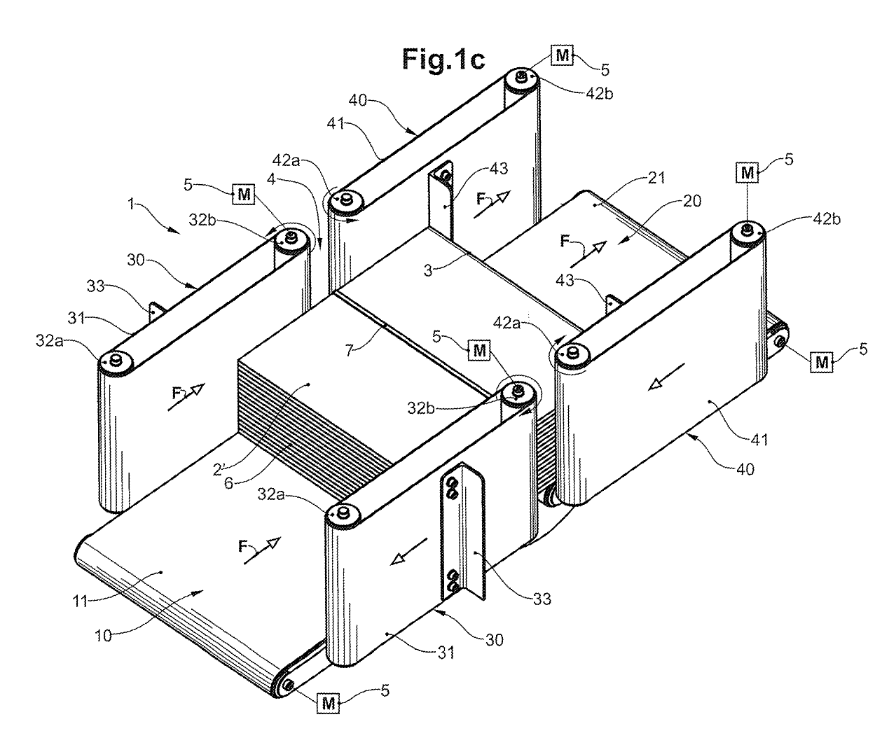

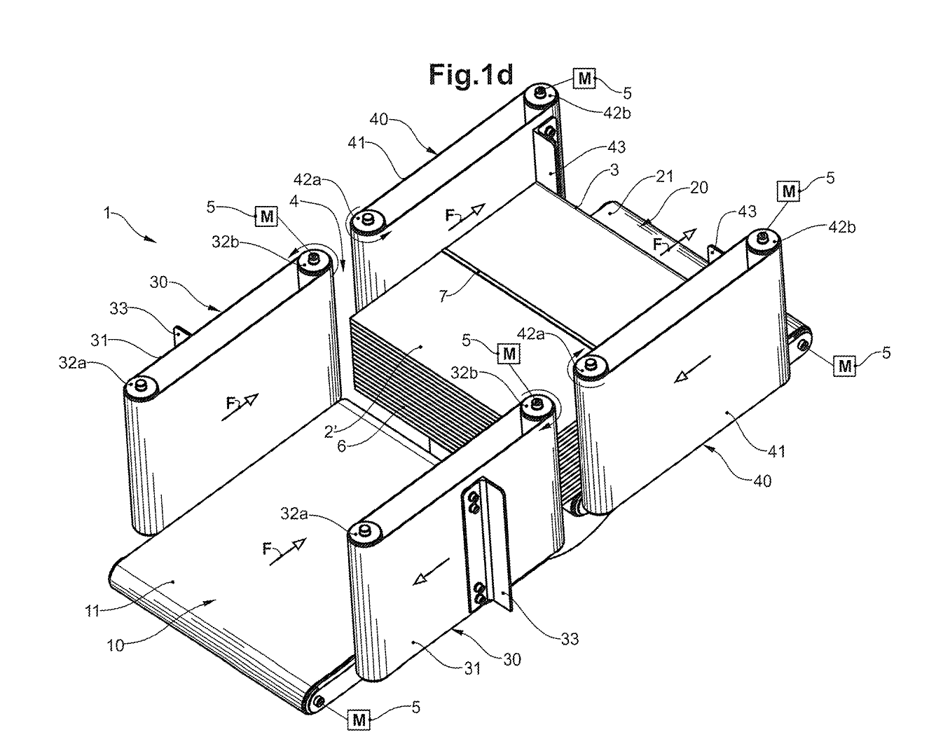

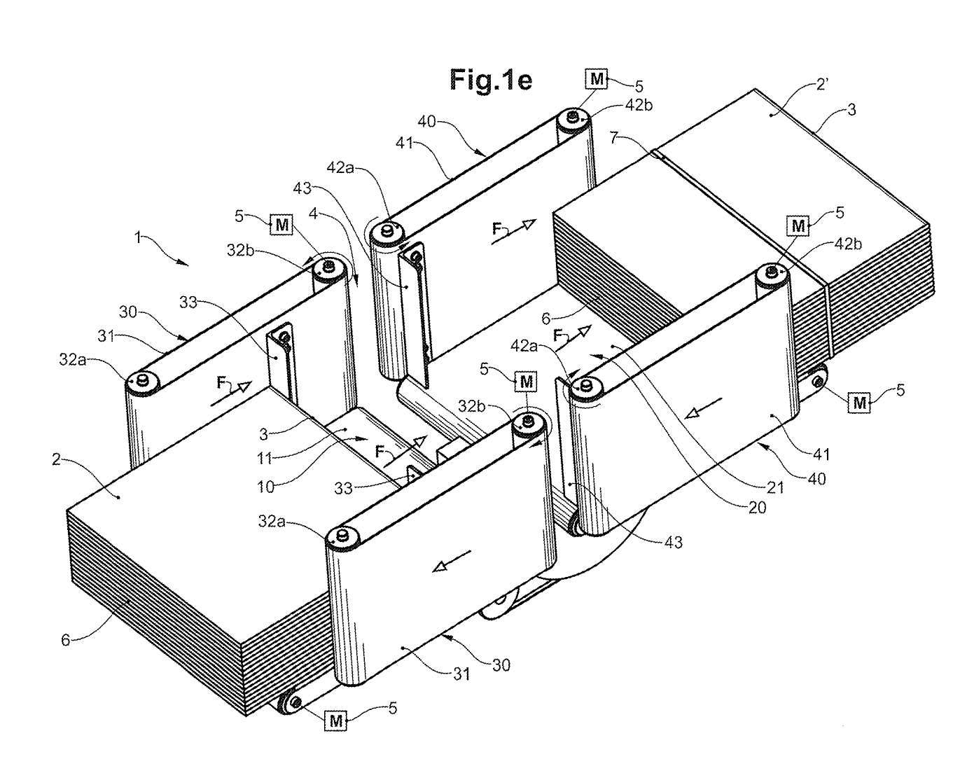

FIGS. 1a to 1e show a first embodiment of the invention and the sequence of the method according to the invention, by way of a chronological picture sequence.

The device 1 includes a first belt conveyor 11 with a first conveying belt which forms a horizontal conveying rest 10. The first belt conveyor 11 or the conveying belt is driven by way of a drive 5.

The device 1 moreover includes a second belt conveyor 21 that is arranged subsequently to the first belt conveyor 11 in the conveying direction F and is with a second conveying belt, which likewise forms a horizontal conveying rest 20. The second belt conveyor 21 or the conveying belt is driven by way of a drive 5. The first and second belt conveyors 11, 21 are driven synchronously to one another.

The two belt conveyors 11, 21 are spaced from one another in the conveying direction F, so that a strapping gap 4 running transversely to the conveying direction F is formed between the first and the second belt conveyor 11, 21.

A side guidance device 30 is arranged in each case laterally of the first belt conveyor 11. The first belt conveyor 1 and the two side guidance devices 30 together form a conveying channel for the product stacks 2.

The side guidance devices 30 in each case include a guiding belt 31, which is guided in a circulatory manner about two deflection rollers 32a, 32b which, in the conveying direction F, are arranged successively and spaced from one another. The deflection rollers 32a, 32b and accordingly the guiding belt 31 are aligned perpendicularly to the conveying rest 10. Accordingly, the guiding belt 31 forms a lateral vertical guide wall.

An advance limitation abutment 33, which is circulatorily co-moved with the guiding belt 31, is arranged on the guiding belt 31. The advance limitation abutment 33 in the conveying channel forms a leading abutment for the product stack 2

Moreover, a side guidance device 40 is likewise arranged in each case laterally of the second belt conveyor 21. The second belt conveyor 21 and the two side guidance devices 40 together likewise form a conveying channel for the products stacks 2, 2′.

The two side guidance devices 40 in each case likewise include a guiding belt 41 that is circulatorily guided about two deflection rollers 42a, 42b, which are arranged successively in the conveying direction F and spaced from one another. The deflection rollers 42a, 42b and accordingly the guiding belt 41 are aligned perpendicularly to the conveying rest 20. Accordingly, the guiding belt 41 forms a lateral, vertical guide wall.

An advance limitation abutment 43, which is circulatorily co-moved with the guiding belt 41, is arranged on the guiding belt 41. The advance limitation abutment 42 in the conveying channel forms a leading abutment for the product stack 2, 2′.

The two pairings of side guidance devices 30, 40 are driven synchronously to one another via drives 5.

The product stack 2 is conveyed to the first belt conveyor 10, for strapping a product stack 2 which, for example, was created in a stacking device. The conveying belt of the belt conveyor 10 as well as the lateral guiding belts 31 of the side guidance devices 30 are hereby driven.

The advance limitation abutments 33 of the two guiding belts 31 are pivoted out of the return section into the conveying channel, before the product stack 2, however, is moved with its front stack side 3 into between the two side guidance devices 30, so that these advance limitation abutments are arranged in a leading manner with respect to the fed product stack (see FIG. 1a).

The movement of the guiding belts 31 and of the advance limitation abutments 33 is synchronised with the feeding of the product stack 2.

The two leading advance limitation abutments 33, which are aligned to one another, form an abutment for the stack side 3, which is at the front in the conveying direction F and together with the product stack 2 are moved in the conveying direction F. If the product stacks 2 has to be braked for certain reasons, then the advance limitation abutments 33 prevent the products or product units from slipping away to the front.

The advance limitation elements 33 are pivoted out of the conveying channel and moved into the return section (see FIG. 1b) when the front stack side 3 reaches the strapping gap 4.

The product stack 2 is now conveyed further in the conveying direction F beyond the strapping gap 4, by way of the first belt conveyor 10.

However, the advance limitation abutments 43 of the two guiding belts 41 are pivoted out of the return section into the conveying channel before the products stack 2 with its leading face edge 2 is moved between side guidance devices 40 of the second belt conveyor 20, so that these advance limitation abutments are arranged in a leading manner with respect to the product stack 2, which crosses the strapping gap 4 in the conveying direction F.

The belt conveyors 11, 21 as well as the guiding belts 31, 41 with their advance limitation abutments 33, 43 are braked and stopped on reaching the strapping position. The product stack 2 in the strapping position lies transversely across the strapping gap 4 (see FIG. 1c).

The advance limitation abutments 43, when stopping the stack 2 in the strapping position, now prevent the products or product units from slipping away to the front.

The product stack 2 is now strapped in the strapping position and subsequently conveyed further in the conveying direction F. The belt conveyors 11, 21 as well as the guiding belts 31, 41 are set into motion again for this.

The strapped product stack 2′ is conveyed out of the strapping position by way of the second belt conveyor 21 (see FIGS. 1d and 1e).

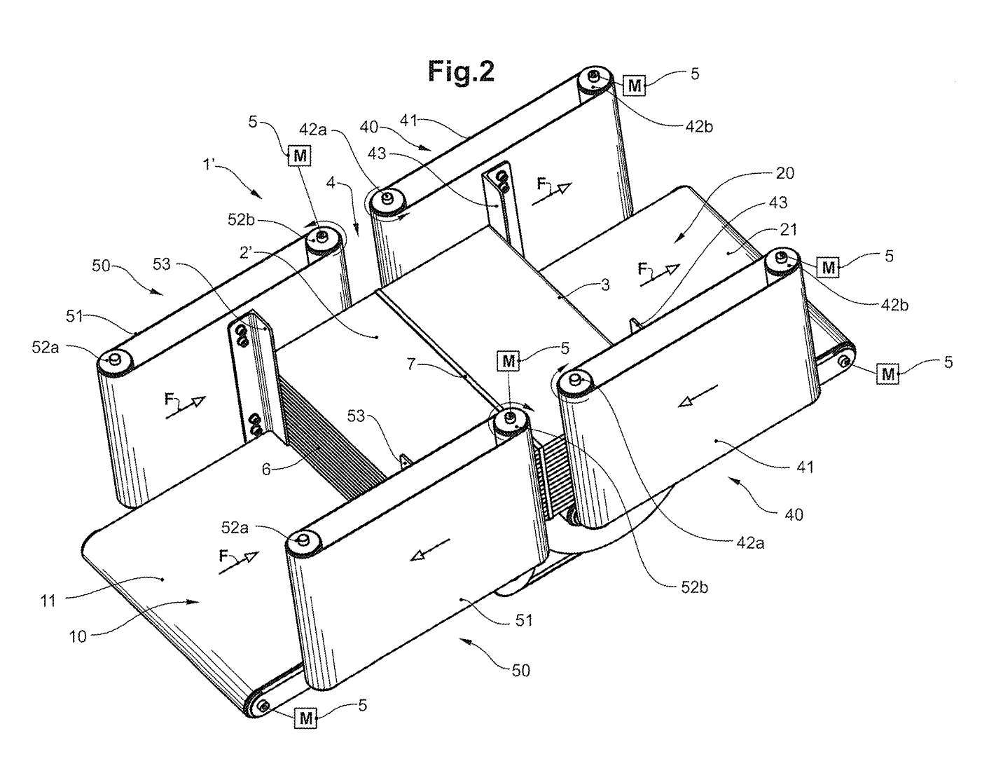

The embodiment of a device 1′ according to the invention shown in FIG. 2 differs from the embodiment according to FIG. 1a-1e in that the side guidance devices 50 associated with the first conveying rest 10 in each case include a guiding belt 51, on which at least one advance abutment 53 is attached instead of at least one advance limitation abutment, and this advance abutment is arranged trailing the product stack 2 conveyed on the first belt conveyor 11. The trailing advance abutments 53 form a guide for the stack side 6, which is at the rear in the conveying direction.

The advance abutments 53 of the two side guidance devices 50 are aligned to one another and are moved synchronously through the conveying channel. They can be moved through the conveying channel in a manner such that the product stack 2 is pushed in the conveying direction F and/or supported to the rear, by way of the advance abutments 53.

The product stack 2 according to this embodiment is now in a position, in which this is arranged transversely over the strapping gap 4, and is guided and supported at its rear stack side 6 as well as at its front stack side 3 by way of suitable abutments 43, 53, in particular in the strapping position.

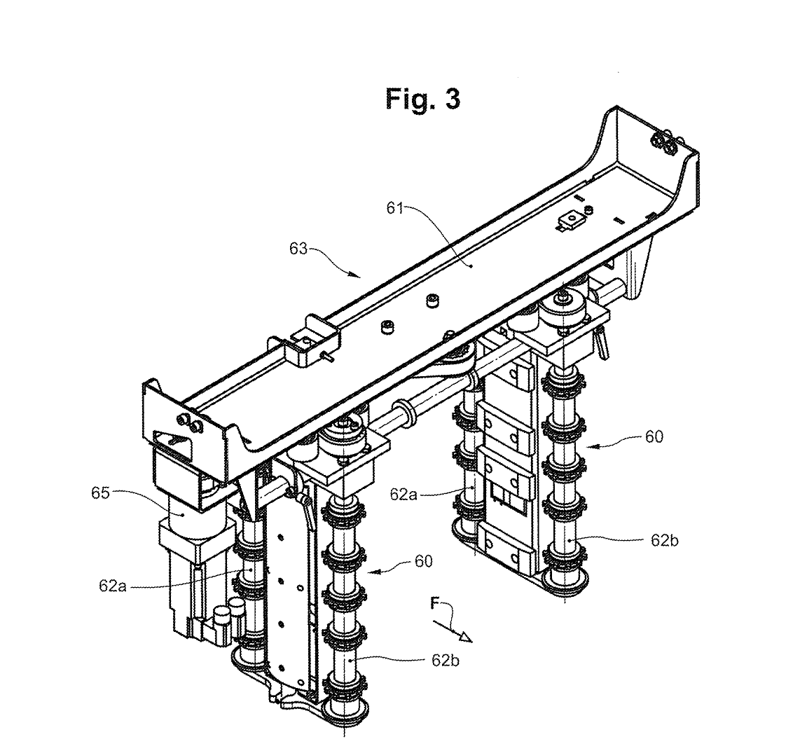

FIG. 3 shows one possible embodiment of the design construction of a side guidance 63 for products stacks 2. The side guide 63 includes a cross-traverse 61, on which two side guidance devices 60, which are spaced from one another, are attached in each case. The cross-traverse 61 is arranged above the side guidance devices 60, wherein the side guidance devices 60 are fastened on the cross-traverse 61 in a hanging manner.

The side guidance devices 60 are represented without the associated guiding belt. Accordingly, the two deflection rollers 62a, 62b are easy visible. The deflection rollers 62a, 62b include drive wheels with a toothing for driving the guiding belts. At least one of the deflection rollers 62a, 62b is driven via a drive 65.

1. A device for strapping product stacks, comprising a first conveying rest and a second conveying rest, which, in a conveying direction, is arranged subsequently to the first conveying rest and spaced from the first conveying rest, wherein a strapping gap for strapping the product stack with a strapping tape is formed between the first and second conveying rests and essentially transversely to the conveying direction,
wherein a side guidance device is arranged in each case at both sides of the second conveying rest considered in the conveying direction, and these side guidance devices laterally guide the product stacks and with the second conveying rest enclose a conveying space, and the side guidance devices each comprise at least one advance limitation element that can be driven in a circulatory manner, projects laterally into the conveying space and is designed to assume a contact fit with the product stack so as to prevent products or product units of the product stack from slipping apart in the conveying direction.

2. The device according to claim 1, wherein the advance limitation element is an advance limitation abutment, which, considered in the conveying direction, can be moved relative to the product stack in a leading manner, in the conveying space.

3. The device according to claim 1, wherein the side guidance device comprises at least one guiding body that is driven in a circulatory manner about at least two deflection elements, which are spaced from one another, and the at least one advance limitation element is arranged on the guiding body.

4. The device according claim 1, wherein a side guidance device is arranged in each case at both sides of the first conveying rest, considered in the conveying direction, and the side guidance devices laterally guide the product stacks and with the first conveying rest form a conveying space.

5. The device according to claim 4, wherein the side guidance device comprises at least one advance limitation element that can be driven in a circulatory manner, projects laterally into the conveying space and is designed to assume a contact fit with the product stack, so as to prevent individual products or product units of the product stack from slipping away in the conveying direction.

6. The device according to claim 5, wherein the advance limitation element is an advance limitation abutment, which, in the conveying space, can be moved in the conveying direction in a leading manner relative to the product stack.

7. The device according to claim 4, wherein the side guidance device of the first conveying rest comprises at least one advance abutment, which can be driven in a circulatory manner and which, in the conveying space and considered in the conveying direction, is movable in a trailing manner relative to the product stack.

8. The device according to claim 5, wherein the side guidance device of the first conveying rest comprises at least one guiding body driven in a circulatory manner about at least two deflection elements that are spaced form one another, and the at least one advance element is arranged on the guiding body.

9. The device according to claim 1, wherein the guiding body is an extensive belt.

10. The device according to claim 1, wherein the at least one advance limitation abutment is strip-like.

11. A method for strapping product stacks with a device according to claim 1, comprising the steps of:
conveying a product stack lying on the first conveying rest in the conveying direction,
receiving the products stack, which is conveyed by the first conveying rest, by the second conveying rest,
conveying the product stack further into a strapping position, in which the product stack is arranged transversely over the strapping gap,
strapping the products stack with a strapping tape,
conveying the strapped product stack further,
wherein the advance limitation element of the at least one side guidance device of the second conveying rest is co-moved in the conveying direction laterally of or leading the product stack, and at least on braking the product stack assumes a contact fit with this, so that products or product units of the product stack cannot slip away in the conveying direction.

12. The method according to claim 11, wherein the advance limitation element is an advance limitation abutment which is co-moved in the conveying direction in a manner leading the product stack and such that products stack or individual product units come to abut on the advance limitation abutment on braking the product stack.
